(19) United States
(12) Patent Application Publication
(10) Pub. No.: US 2005/0076998 A1
(43) Pub. Date: Apr. 14, 2005

(54) Rhinestone kit

(76) Inventors: Thomas Buffum, Hawthorn, NY (US); Robert Fishman, Hastings-on-Hudson, NY (US)

Correspondence Address: GOTTLIEB RACKMAN & REISMAN PC, 270 MADISON AVENUE, 8TH FLOOR, NEW YORK, NY, 100160601, US

(21) Appl. No.: 10/962,061

(22) Filed: Oct. 8, 2004

Related U.S. Application Data
(60) Provisional application No. 60/510,656, filed on Oct. 10, 2003.

(51) Int. Cl. B44C 1/165; B32B 31/00

(52) U.S. Cl. 156/230; 156/539

(57) ABSTRACT

A unique system for creating a crystal design along an item of apparel is provided. The system includes a plurality of rhinestones, a re-usable grid board having a plurality of dimples, each suitable for selectively receiving any one of said rhinestones, thereby enabling the creation of a pre-arranged rhinestone pattern along the board, and means for permanently applying the pre-arranged rhinestone pattern to a desired location along the item of apparel.

### BACKGROUND OF THE INVENTION

This application is based on and claims priority of U.S. provisional application No. 60/510,656, filed Oct. 10, 2003.

This application is directed to a system for creating unique and decorative crystal designs on a garment or item of apparel. Adhere transfer systems have been widely used in the application of indicia such as designs, pictures, letters, numbers and figures, marks etc. where the indicia is permanently bonded to a t-shirt or other item of fabric. Such adhere transfers generally include an individual carrier sheet containing a design or other indicia. The designs are generally formed of an adhesive ink which, when applied to receiving fabric, the carrying sheet and design are placed in direct immediate contact with the fabric surface while heat, such as that supplied by an iron or the like, is applied on the oppositely disposed side of the carrier paper. While this system is suitable for the transferred adhesive inks onto fabric, it has never been suggested that such a system would be suitable for the use in creating crystal designs along a fabric.

In the patent to Lewis, U.S. Pat. No. 5,634,996, there is described a method of adhering studs through cloth. Each stud include a low temperature heat sensitive adhesive applied to the backside thereof. A stud pattern sheet is used to replicate the pattern on a cloth. In use, the studs are placed on the cloth along that pattern and a hot iron is placed on the pattern studs in order to activate the adhesive applied to the backsides thereof and do thus adhere the studs to the cloth.

While the Lewis patent is of interest, if fails to teach or suggest a system which enables the pre-arrangement of any desired pattern for crystal elements such as rhinestones and the like that can subsequently be applied to an item of apparel.

### SUMMARY OF THE INVENTION

Generally speaking, in accordance with the invention, a unique system for creating a crystal design along an item of apparel is provided. The system includes a plurality of rhinestones or other crystal members, a re-usable grid board having a plurality of dimples each suitable for selectively receiving any one of the rhinestones, thereby enabling the creation of a pre-arranged rhinestone pattern along the board, and means for permanently applying the pre-arranged rhinestone pattern to a desired location along the item of apparel.

In one embodiment, the re-usable grid board allows the user to create his or her own designed pattern. In an alternative embodiment, the board may include a pre-determined design pattern thereon. In either case, the rhinestones are arranged and received along the plurality the dimples of the board in a specified and desired design.

In one embodiment, stick paper is applied to the rhinestone grid design and then placed on a desired location along the item of apparel, after which a hot iron is applied to the back of the paper in order to transfer the rhinestone pattern onto the apparel item. Alternatively, the rhinestone pattern is placed directly on the apparel item with a hot iron or other heating element is placed over the apparel item.

Accordingly, it is an object of the invention to provide an improved system for creating a crystal design along an item of apparel.

Still another object of the invention is to provide a system for creating a crystal design on an item of apparel by means of a re-usable grid board or other rigid material having a plurality of dimples suitable for receiving conventional rhinestones.

Yet a further object of the invention is to provide a system for creating any type of crystal or rhinestone design pattern along an item of apparel.

Still other objects of the invention will, in part, be obvious and will, in part, be apparent from the following description.

### BRIEF DESCRIPTION OF THE DRAWINGS

For a fuller understanding of the invention, reference is made to the following description, taken in connection with the accompanying drawings, in which:

FIG. 1 is a top plan view of a plurality of rhinestones suitable for use in the inventive system;

FIG. 2 is top plan view illustrating the application of the rhinestone crystals of FIG. 1 to a grid board in order to create a pre-arranged pattern;

FIG. 3 is a perspective view showing the cutting and peeling back of stick transfer paper;

FIG. 4 is a top plan view showing placement of the stick transfer paper over the rhinestone design pattern of FIG. 2;

FIG. 5 is a perspective view showing the release of the stick transfer paper, with a pre-arranged rhinestone pattern thereon, from the grid board;

FIG. 6 is a top plan view showing placement of the stick transfer paper with the pre-arranged rhinestone pattern thereon applied to a desired location of a garment;

FIG. 7 is a top plan view showing a portion of the garment of FIG. 6 with an applied rhinestone pattern; and

FIG. 8 is a top plan view of a grid board with one or more designs pre-formed thereon.

### DETAILED DESCRIPTION OF THE PREFERRED EMBODIMENT

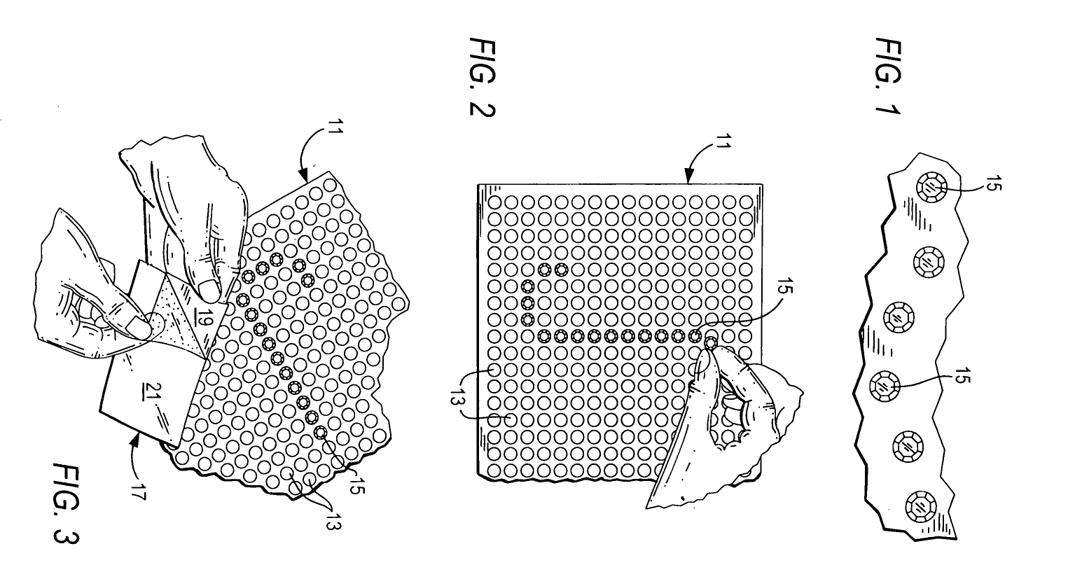

Referring to FIG. 1, a plurality of rhinestones suitable for use in accordance with the invention and generally indicated at 15 are shown. Rhinestones 15 may be of different colors and are typically pre-glued on the back side (not shown) so that there is no mess during transfer, as described later on.

In FIG. 2, a grid board 11 suitable for use in the inventive system is shown. Grid board 11 includes a plurality of dimples 13 suitable for selectively receiving one more of rhinestones 15. Grid board 11 in combination with rhinestones 15 are used to form any type of desired rhinestone design pattern.

In accordance with the invention, once a particular design pattern of rhinestones is selected, individual rhinestones are placed in appropriate dimples 13 of grid board 11 so as to reflect the chosen pattern. When placing the rhinestones onto grid board 11, they can be arranged with any combination of colors, or with just one color. Importantly, rhinestones 15 should be placed within dimples 13 of grid board 11 with the flat or back side (the non crystal portion) down. Each rhinestone 15 is already applied with hot fix glue along the flat or back side so no extra glue is typically required.

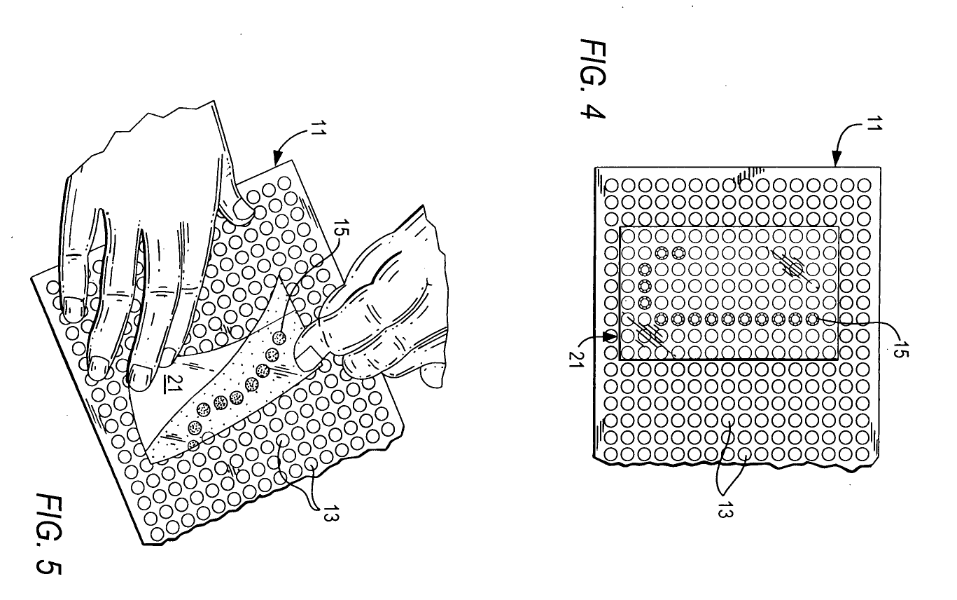

After the desired rhinestone pattern has been created along grid board 11, a piece of stick transfer paper 17 is cut out having sides that will define at least a one inch border around the design pattern. Stick paper 17 comprises a backing 19 and a peeled-off portion 21 with a back sticky side. In use, once peeled, the sticky side of peel-off potion 21 is placed on top of the rhinestone pattern formed along grid board 11, as shown in FIG. 4. Once positioned appropriately, peel-off portion 21 with the now stuck rhinestones is picked up so that the rhinestone design pattern remains intact along the back of peel-off portion 21—see FIG. 5.

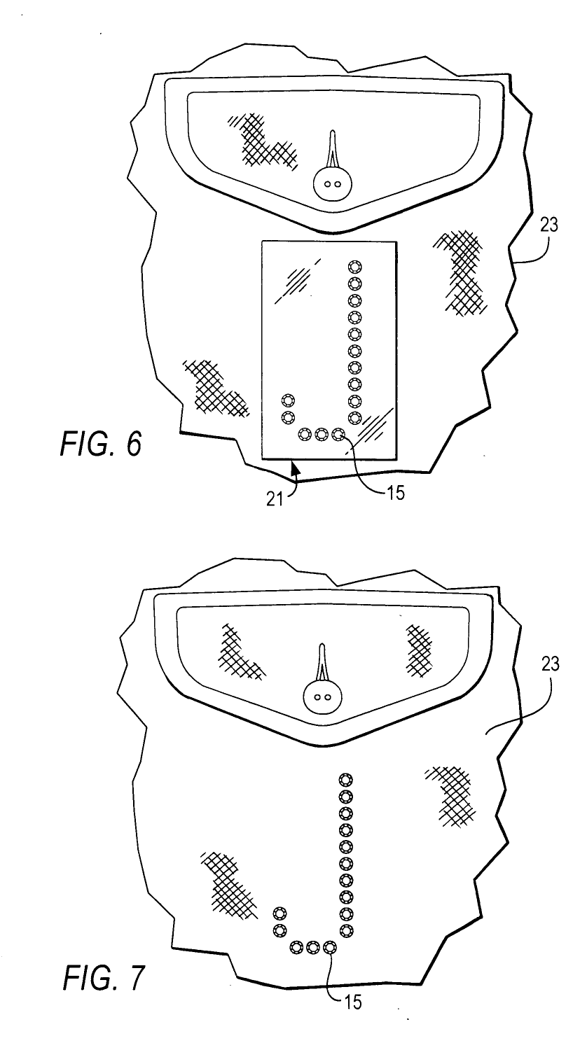

Now turning to FIG. 6, peel-off portion 21 of stick transfer paper 17, which now carries the rhinestone design pattern, is placed along a portion of garment 23 TO which the rhinestone pattern is to be fixed. Once positioned, as shown in FIG. 6, garment is turned over and then ironed from the reverse side or back of the garment material. Preferably, once the iron is heated up, it is placed along the back of the garment material so that the rhinestone pattern is covered by the iron and heated. Thereafter, the iron is removed, and the garment material is allowed to cool. Then, peeled-off peel-off portion 21 of stick paper 17 is removed from the rhinestone pattern. If necessary, the ironing process may be repeated to facilitate rhinestone adherence to the garment. The finished garment (see FIG. 7) will now bear the previously created rhinestone pattern fixed thereon.

Alternatively, instead of using stick transfer paper, the pre-arranged pattern of rhinestones is applied directly to the garment or apparel item by placing the desired location of the garment or apparel item on top of the grid board, over the pre-arranged rhinestone pattern, and then placing a hot iron or other heating element on top of the garment or apparel item.

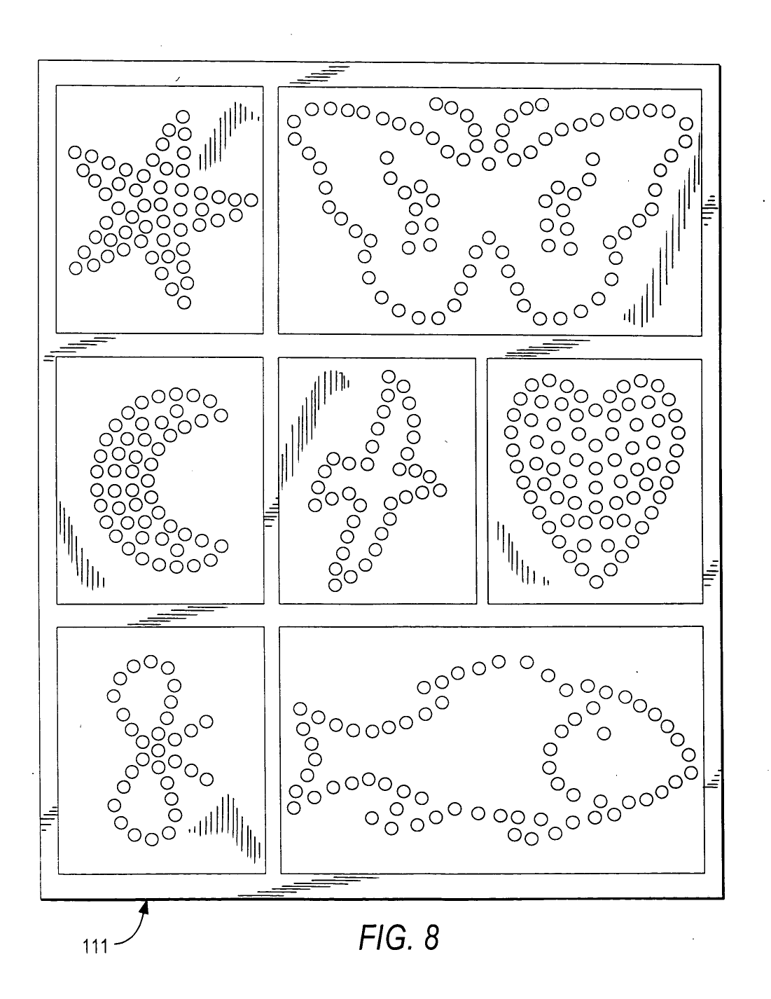

Alternatively, as shown in FIG. 8, a grid board 111 may be used, which includes pre-determined design patterns formed thereon from which the user can select, instead of the user creating his or her own unique rhinestone design patterns.

It will thus be seen that the objects set forth above, among those made apparent from the preceding description, are efficiently attained, and it is also understood that the invention contains any and all changes and modifications thereto which would be apparent to one of ordinary skill in the art and which come within the spirit and scope of the inventive concept.

1. A system for creating a crystal design along an item of apparel comprising:
a plurality of rhinestones or other crystal elements;
a re-usable grid board having a plurality of defined locations for selectively and fixedly locating any number of said rhinestones in order to enable the creation of a rhinestone pattern along said board; and
means for permanently applying said rhinestone pattern to an area of said item of apparel.

2. The system of claim 1, wherein said rhinestones are of different colors.

3. The system of claim 2, wherein said grid board includes one or more pre-determined patterns.

4. The system of claim 1, wherein said transfer means comprises stick transfer paper.

5. The system of claim 4, wherein said transfer means further comprises a heating element in combination with said stick transfer paper.

6. The system of claim 1, wherein each said defined location comprises a dimple element suitable for selectively receiving any of said rhinestones.

7. A method for creating a crystal design along an item of apparel comprising:
creating a design pattern of rhinestones or other crystal elements along a grid board by selectively and fixedly placing said rhinestone at a defined locations on said grid board;
transferring said design pattern of rhinestones from said grid board to a desired location along said item of apparel; and
applying heat to said location so that said design pattern of rhinestones is permanently adhered to said item of apparel.

8. The method of claim 7, wherein said transfer step comprises applying stick tranfer paper over said design pattern of rhinestones in order to carry said design pattern of rhinestones and placing said carried design pattern of rhinestones onto said apparel location; and

9. The method of claim 7, wherein each said rhinestones are selectively received within a dimple found at said defined locations.
